(19) United States
(12) Patent Application Publication
(10) Pub. No.: US 2007/0136487 A1
(43) Pub. Date: Jun. 14, 2007

(54) Contents providing system and method for streaming service

(76) Inventors: Sang Min Woo, Daegu (KR); Chang Soo Kim, Daejeon (KR); Yoo Hyun Park, Daejeon (KR); Won Jae Lee, Daejeon (KR); Ok Gi Min, Daejeon (KR); Han Young Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/523,198

(22) Filed: Sep. 19, 2006

(30) Foreign Application Priority Data
Dec. 8, 2005 (KR) 10-2005-0120179
Mar. 16, 2006 (KR) 10-2006-0024387

(51) Int. Cl. G06F 15/16

(52) U.S. Cl. 709/231

(57) ABSTRACT

A content providing system and method for a streaming service are provided. The content providing system is connected to at least one of wired/wireless terminals and a wide area server. The content providing system includes at least one of local servers and a manage node. The local servers store contents received from the wide area server and provide context index information. The managing node manages the context index information by the contents stored in the local servers and the wide area server, and determines a storing location of a corresponding content from the context index information if a content request message is received from a terminal. Also, the managing node transmits the requested content to the terminal through a wired/wireless Internet network by transmitting a content-transmission message to local servers having the corresponding content or the wide area server.

### RELATED APPLICATION

The present application is based on, and claims priority from, Korean Application Number 2005-0120179, filed Dec. 8, 2005 and Korean Application Number 2006-0024387, filed Mar. 16, 2006, the disclosure of which is hereby incorporated by references herein in its entirety.

### BACKGROUND OF THE INVENTION

1. Field of the Invention

The present invention relates to a contents providing system and method for a streaming service, and more particularly, to a contents providing system and method for supporting a contents streaming service in a wireless/wired user terminal environment.

2. Description of the Related Art

The development of high-speed Internet technology and the high penetration rate of the high-speed Internet encourage users to demand various related services. In order to satisfy such demands, a streaming service was introduced. The streaming service allows a user to receive various multimedia services in real time through the Internet using a mobile terminal such as a portable phone, a notebook and a personal data assistant (PDA) or a computer terminal. Such a streaming service has been popularized, and the number of subscribers for the streaming service has explosively increased.

Streaming is a media delivering scheme for reproducing multimedia data such as audio, video or animation on the Internet in real-time. In streaming, large multimedia data is divided into small files, and the divided small files are transmitted to a user's computer. The user's computer starts to reproduce the received multimedia files if the predetermined portion of the entire multimedia file is arrived at the user's computer. Then, the user's computer receives the remained portion of the entire multimedia file while reproducing the received portion of the multimedia file. A streaming service was developed to provide a seamless multimedia service to a user without interruption by providing a service with the minimized delay time. Therefore, in order to provide a high-quality seamless streaming service to a user, related contents must be provided with minimum delay by selecting the best one among servers which can provide the related contents.

However, if the selected server does not store corresponding contents, or if the selected server is in an overload state, the corresponding contents must be duplicated from servers having the corresponding contents to the selected server or from the selected server to servers with small load. In this case, the contents must be carefully transmitted in order to provide a reliable service to a user.

Generally, the content transmission scheme of the streaming service system was defined by a standard transport protocol such as FTP, and a content was transmitted from its a start point. According to the contents transmission scheme defined by the standard transport protocol, the streaming service is interrupted until a content requested by a user is received. That is, a low-quality streaming service was provided to a user.

In order to provide a high-quality streaming service, a content providing method using a local cache was introduced. In this conventional method, video files are transmitted to a local cache in a local area communication network using a common video library and a wide area communication network in order to quickly response to a user's request. Also, a method for minimizing a delay time between a web subscriber and an edge server was introduced. In this conventional method, the best edge server for providing a corresponding content is selected among edge servers according to whether an edge server stores a corresponding content or not, the usability of an edge server, the load of an edge server, and a distance between an edge server and a web subscribe. Then, the contents are provided to web subscribers with the minimum delay time using the selected edge server. Furthermore, a method for distributing contents based on a caching concept was introduced.

However, although these conventional methods are used to provide a streaming service, the streaming service is also interrupted until a corresponding content requested by a user is transmitted to a predetermined location when contents are exchanged between servers. When a user receives a streaming service while traveling between the coverage areas of servers, the streaming service is also interrupted while a corresponding content is transmitted to a server that provides the streaming service to the user.

### SUMMARY OF THE INVENTION

The present invention provides a system and method for providing contents for a streaming service that substantially obviates one or more problems due to limitations and disadvantages of the related art.

An object of the present invention is to provide a convent providing system and method for providing a high-quality streaming service by effectively distributing contents that are provided from each streaming server when a streaming service system provides a streaming service to a user according to the request of a user.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a content providing system for supporting a streaming service by being connected to at least one of wired/wireless terminals and a wide area server, the content providing system includes: at least one of local servers for storing contents received from the wide area server and providing context index information of the contents; and a managing node for managing the context index information by the contents stored in each of the local servers and the wide area server, determining a location of storing a corresponding content from the context index information according to type information of the corresponding content if a content request message is received from a terminal, and transmitting a content-transmission message to local servers having the corresponding content or the wide area server so that the local servers or the wide area server transmit the content requested by the terminal to the terminal through a wired/wireless Internet network.

The context index information may include at least one of information about identification of each of the contents, storing location of each of the contents, and starting information or end information of the stored content.

The wide area server may transmit the context index information of each of the contents to the content providing system and transmit an entire content or a partial content to a corresponding terminal according to a content transmission message received from the content providing system.

The managing node may search local servers that store the entire content if the content type information included in the content request message is entire content information, and may transmit the content transmission message to the wide area server if no local server having the entire content is searched.

The managing node may search local servers having a partial content if the content type information included in the content request message is partial content information, and may transmit the content transmit message to the wide area server if no local server having the partial content is searched.

If a content requested through the content request message is distributed into at least one of local servers, the managing node may sequentially transmit a content transmission message to corresponding local servers or the wide area server according to start and end information of the content stored in each local server in order to sequentially transmit the distributed contents stored in the local servers or the wide area server.

The content transmission message may include at leas one of information about storing locations of the content, a user process registration identification, a server process registration identification, a size of content to transmit, start information, end information and a content transmit rate. Herein, the managing node decides the content transmit rate by measuring a bandwidth and a processing capacity of the each local server or the wide area server for transmitting contents.

The content request message may include at least one of information about a user account, a user account password, an address of a terminal, an address of a managing node and a content type.

The local server or the wide area server may include a content transmission managing unit for managing the stored context index information, and transmitting the content to a corresponding terminal according to content size information, start information and end information in the received content transmission message.

The content transmission managing unit may includes: an index managing unit for managing the stored context index information; a process analyzing unit for analyzing a content transmission type when a content transmission message is received, and determining whether the content is stored or not using the index information; a content processing unit for reading a corresponding content according to storing location information, start information or end information of the content, which are checked at the process analyzing unit, and storing contents received from other local servers or the wide area server; a content transceiving unit for transmitting the contents read from the content processing unit or receiving contents from the wide area server or other local servers; and a content state processing unit for transmitting content index information and content state information, which are managed in the index processing unit, to a managing node.

According to an aspect of the present invention, there is provided a streaming service system including: at least one of terminals for receiving a content through a wired/wireless Internet network and providing a streaming service to a user; a wide area server for storing contents for a streaming service and transmitting the contents; and at least one of content providing systems including at least one of local servers for storing contents received from the wide area server, managing content index information of contents stored in each of the local servers and the wide area server, and transmitting contents from a corresponding local server or the wide area server to a corresponding terminal by checking content index information according to a content request message received from each of the terminals.

The content providing system may include: at least one of local servers for storing contents received from the wide area server and providing index information of the contents; and a managing node for managing the index information by the contents stored in each of the local servers and the wide area server, determining a location of storing a corresponding content from the index information according to type information of the corresponding content if a content request message is received from a terminal, and transmitting the requested content to the terminal through a wired/wireless Internet network by transmitting a content-transmission message to local servers having the corresponding content or the wide area server.

According to another aspect of the present invention, there is provided a method of providing contents for supporting a streaming service in a content providing system connected to at least one of wired/wireless terminal and a wide area server, including the steps of: a) at each of the local servers, storing contents received from the wide area server; b) at a managing node, managing content index information by the contents stored in each of the local servers; c) detecting local servers having a corresponding content by analyzing the content index information if a content request message is received from a terminal through a wired/wireless Internet network, and transmitting a content transmission message to the detected local server; and d) at the detected local server, transmitting the content to the corresponding terminal.

The content index information may include at least one of information about identifications of each of the contents, storing locations of each of the contents, and start and end information of the stored contents.

The step b) may include the steps of: b-1) at the wide area server, transmitting content index information to the managing node; and b-2) at the managing node, managing the content index information stored in each of the local servers and the wide area server.

The content request message may include at least one of information about a user account, a user account password, an address of a terminal, an address of a managing node and a content type.

In the step c), local servers that store an entire content may be searched if the content type information included in the content request message is entire content information, and a content transmission message may be transmitted to the wide area server if no local server having the entire content is searched.

In the step c), local servers having a partial content may be searched if the content type information included in the content request message is partial content information, and a content transmit message may be transmitted to the wide area server if no local server having the partial content is searched.

In the step c), if a content requested through the content request message is distributed into at least one of local servers, a content transmission message may be sequentially to corresponding local servers or the wide area server according to start information and end information of the content stored in each local server in order to sequentially transmit the distributed contents stored in the local servers or the wide area server.

In the step c), a partial content requested from a user may be selected according to content size information, start information and end information in the received content transmission message, and the selected partial content is transmitted.

The content transmission message may include at leas one of information about storing locations of the content, a user process registration identification, a server process registration identification, a size of content to transmit, start information, end information and a content transmit rate.

The managing node may decide the content transmit rate by measuring a bandwidth and a processing capacity of the each local server or the wide area server for transmitting contents.

In the step d), the local server or the wide area server may select a corresponding content according to content storing location information and content size information included in a content transmission message, and the selected content is transmitted to a corresponding terminal according to the content transmit rate.

The method may further include the steps of: receiving a content from the wide area server or other local servers, and storing the received content; managing content index information stored in each of the local servers and the wide area server; analyzing a content transmission type if a content transmission message is received, and determining whether a corresponding content is stored or not from the content index information; reading a corresponding content according to the content index information and transmitting the read content to a corresponding terminal; and transmitting content index information and content state information to a managing node.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a streaming service system where the present invention is applied;

FIG. 2 is a block diagram illustrating a content providing system according to an embodiment of the present invention;

FIG. 3 is a block diagram illustrating a content transmission managing unit according to an embodiment of the present invention;

FIG. 4 is a view for describing the management of the context index information according to an embodiment of the present invention;

FIG. 5 is a view for describing the transmission of a content according to an embodiment of the present invention; and

FIG. 6 is a flowchart illustrating a method of providing contents according to an embodiment of the present invention.

### DETAILED DESCRIPTION OF THE INVENTION

Reference will now be made in detail to the preferred embodiments of the present invention, examples of which are illustrated in the accompanying drawings.

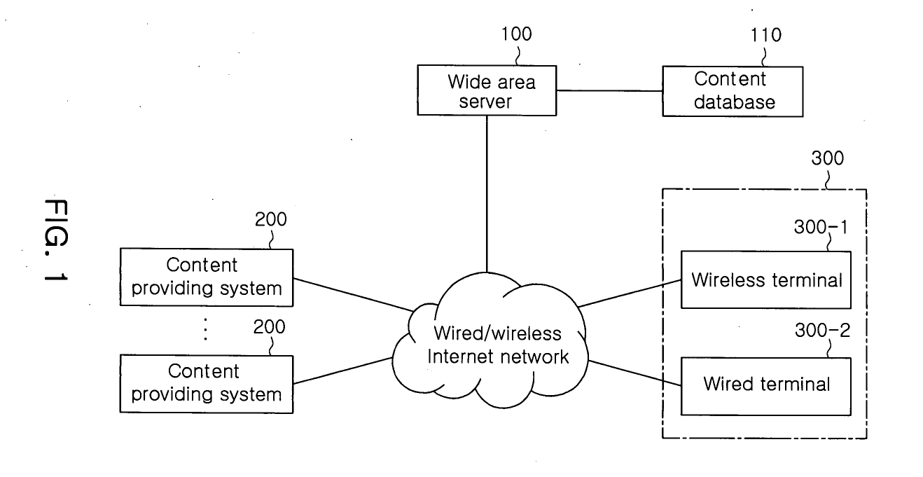

FIG. 1 is a block diagram illustrating a streaming service system where the present invention is applied.

Referring to FIG. 1, the streaming service system according to the present embodiment includes a wide area server 100, a content database 110, a plurality of content providing systems 200, a wireless terminal 300-1, and a wired terminal 300-2. The wide area server 100, each of the content providing systems 200 and each of the terminals 300 include a communication unit for communicating each others through a wired/wireless Internet network (hereinafter, an Internet network), and are connected each others through the Internet network.

The wide area server 100 provides all contents which are requested by a user using a terminal 300, and the content database 110 stores the all contents provided from the wide are server 100. The content database 110 may be included in the wide area server 100 or may be provided as an independent storage device. The wide area server 100 transmits contents stored in the content database 110 to each of the content providing systems 200. Also, the wide area server 100 transmits the context index information of the contents stored in the content database 110 to the content providing systems 200. The context index information of the contents may include information about locations that store each content, and start and end information of a content stored in each storing location.

The terminal 300 accesses each of the content providing systems 200 through the Internet network, transmits a content request message, and outputs multimedia according to the received contents so as to provide a streaming service.

Each of the content providing systems 200 manages the context index information of available contents and provides a corresponding content when a content request message is received from a terminal 300. If a content providing system 200 does not have a content requested by a terminal 300, the content providing system 200 requests other content providing systems 200 or the wide area server 100 to transmit the requested content to the terminal 300. Herein, it is preferable that the content providing systems 200 according to the present embodiment may be embodied as a cluster based system including multiple independent servers.

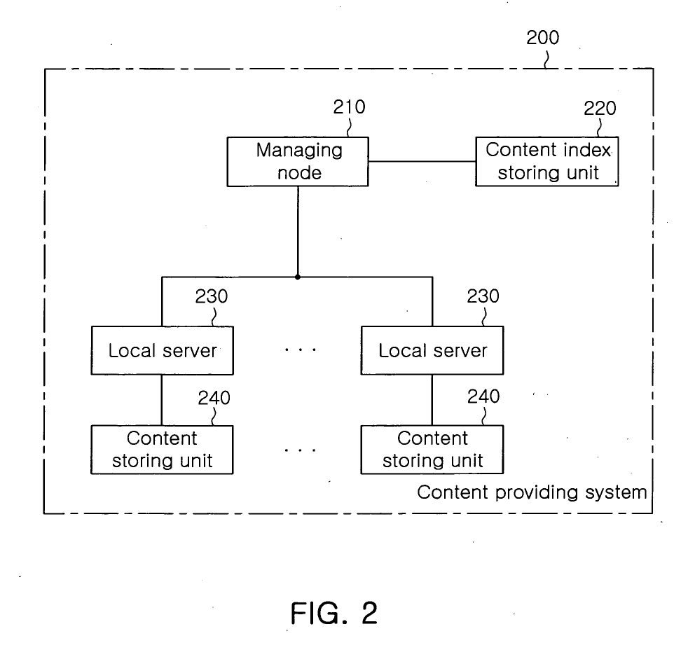

FIG. 2 is a block diagram illustrating a content providing system according to an embodiment of the present invention.

Referring to FIG. 2, the content providing system 200 according to the present embodiment includes a managing node 210, a content index storing unit 220, a plurality of local servers 230, and a plurality of content storing units 240 connected to the local server 230.

The content storing unit 240 may be included in each of the local servers 230 as an internal storing unit, or may be separated provided as an external independent storing unit. The local server 230 transmits contents stored in the content storing unit 240 to the terminal 300 or the other local server 230.

The managing node 210 and the local server 230 include a communication unit for communicating each others within the content providing system 200 and exchange information and messages through the communicating unit.

The content index storing unit 220 stores the context index information of available contents which can be provided from each local server 230 and the wide area server 100.

The managing node 210 stores and manages the context index information of available contents which can be provided from the local servers 230 and the wide area server 100. When a content request message is received from the terminal 300, the managing node 210 transmits requested contents from the local servers 230 having the requested contents or the wide area server 100 to the terminal 300. Also, the managing node 210 searches local servers 230 and a wide area server 100 which can provide the requested contents when the content request message is received, transmits a content transmission message to the searched local servers 230 and wide area server 100 so as to enable a corresponding terminal 300 to provide a streaming serve by receiving contents.

Each of the local servers 230 may function as an independent server under the content providing system 200 which is formed as a cluster type. Each of the local servers 230 transmits requested contents to each terminal 300. Each of the content storing units 240 connected to each of the local servers 230 stores contents received from the wide area server 100.

Each of the local servers 230 and the wide area server 100 transmit the context index information of available contents to the managing node 210 of the content providing system 200.

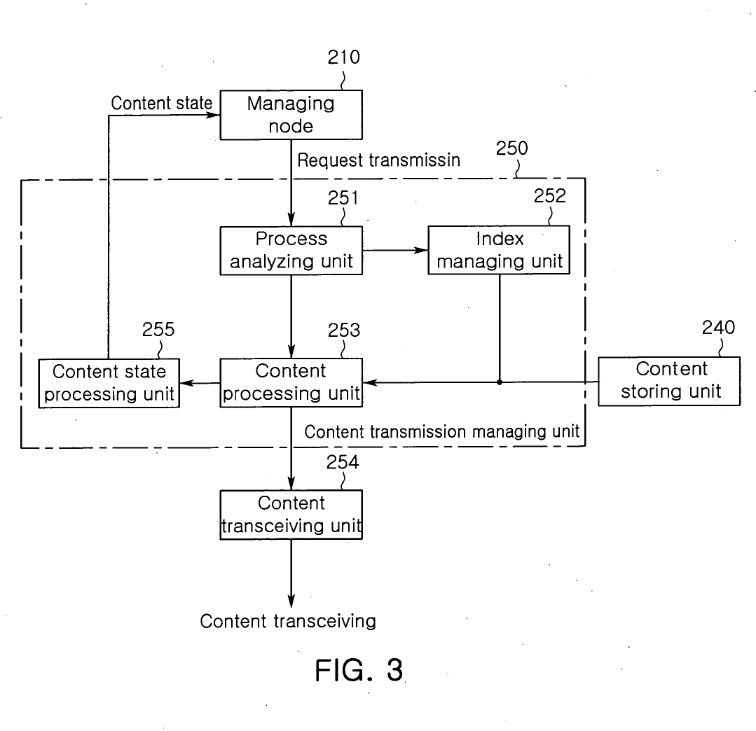

FIG. 3 is a block diagram illustrating a content transmission managing unit according to an embodiment of the present invention.

Referring to FIG. 3, the content transmission managing unit according to the present embodiment may be included in each of the local servers 230. The content transmission managing unit according to the present embodiment includes a process analyzing unit 251, an index managing unit 252, a content processing unit 253, a content transceiving unit 254, and a content state processing unit 255.

The index managing unit 253 manages the context index information of contents stored in the content storing unit 240, that is, manages the storing location information, the start information and the end information of the contents stored in the content storing unit 240.

The process analyzing unit 251 checks the content type transmission, such as whether it is an entire content type transmission or a partial content type transmission, when a content transmission message is received from the managing node 210. If it is the partial content type transmission, the processing analyzing unit 251 checks storing location information of a corresponding content, and the start and end information of the corresponding content. The process analyzing unit 251 determines whether a corresponding content is stored in the content storing unit 240 or not.

When contents are received from the wide area server 100 or other local servers 230, the content processing unit 253 stores or writes the received contents in the content storing unit 240. The content processing unit 253 also reads a corresponding content from the content storing unit 240 according to the received content transmission message. Herein, the index managing unit 252 updates the context index information of new contents when the content processing unit 253 stores or writes contents in the content storing unit 240.

The content transceiving unit 254 transmits contents which are read from the content processing unit 253 to a terminal 300 through the Internet network, or receives contents from the wide area server 100 or other local servers 230.

The content state processing unit 255 transmits the context index information of contents and the state information of the local server 230, which are managed at the index managing unit 252, to the managing node 210.

The managing node 210 may manage the context index information of contents received from each local server 230 and the wide area server 100 as a table form.

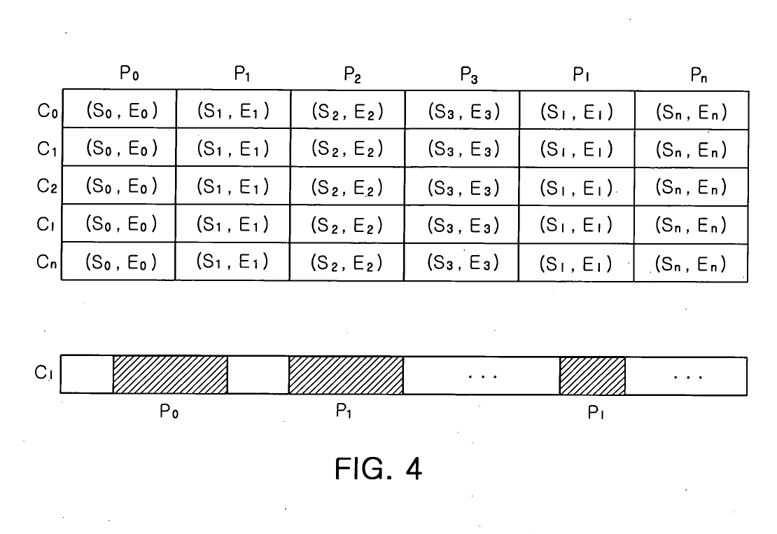

FIG. 4 is a view for describing the management of the context index information of contents according to an embodiment of the present invention.

Referring to FIG. 4, the managing node 210 may manage the storing locations P of contents C which can be provided from each local server 230 or the wide area server 100, and manages the start information S and the end information E of a content stored in each of the storing location P. Herein, the storing locations P may be identification information of the local server 230 or the wide area server 100 or the location information of storing areas in the corresponding local server 230 or the wide area server 100. That is, when a content is distributed into a plurality of local servers 230 or the wide area server 110, the managing node 210 manages the storing locations P that store the distributed contents Ci, and the start and end information S and E of a content stored in a corresponding storing location P. When a content is distributed into a plurality of local servers 230 and the wide area server 100, the start information S and the end information E of a distributed content define that which part of the entire content is stored in a corresponding storing location P.

When a content request message is received from a terminal 300, which requests a content that is distributed throughout several different locations, the managing node 210 searches the local servers 230 or the wide area server 100 that sequentially store the distributed contents, and controls the corresponding local server 230 or the wide area server 100 to sequentially transmit the distributed contents so as to transmit the entire content to the terminal 300.

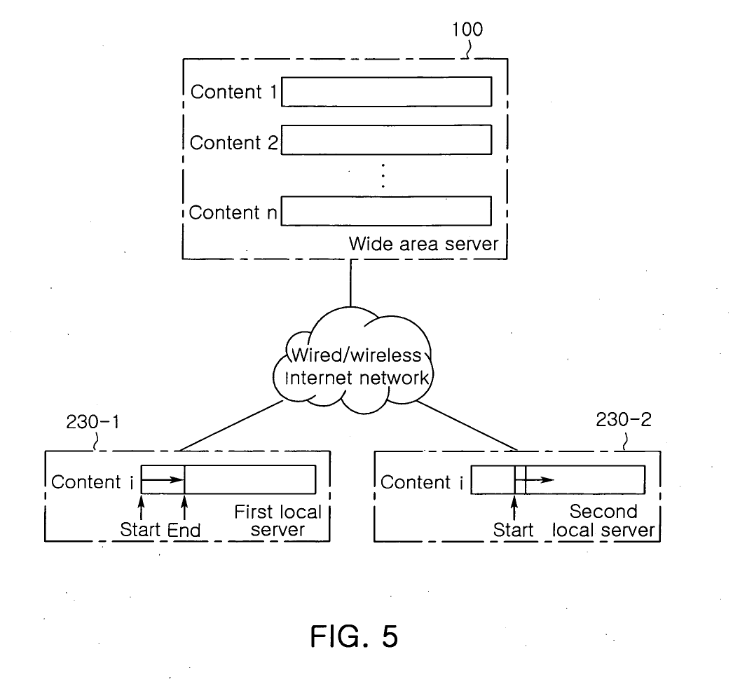

FIG. 5 is a view for describing the transmission of a content according to an embodiment of the present invention.

Referring to FIG. 5, when the content Ci to transmit is distributed to a first local server 230-1 and a second local server 230-2, the managing node 210 checks the storing locations P, the start and end information S and E of a content stored in each local server 230 from content context index information according to a content request message received from the terminal 300.

Also, if initial start information is present in the first local server 230-1, the managing node 210 transmits a content transmission message to the first local server 230-1 in order to instruct the first location server 230-1 to transmit the content stored in the corresponding storing location. When the first local server 230-1 receives the content transmission message, the first local server 230-1 transmits the predetermined content from the start information to the end information of a content i, which is stored in the content storing unit 240, to the corresponding terminal 300.

Since the second local server 230-2 stores the remained portion from the end information of the content i stored in the first local server 230-1, the managing node 210 transmits a content transmission message to the second local server 230-2, and the second local server 230-2 transmits the remained portion of the content i stored in the content storing unit 240 to the terminal 300.

Therefore, the managing node 210 manages the local servers 230 and the wide area server 100 to sequentially transmit the distributed contents to the terminal 300 according to the content request message received from the terminal so as to provide the entire content although the content is distributed to a plurality of local servers 230 or the wide area server 100. Therefore, the streaming service is provided without interruption.

The content request message transmitted from the terminal 300 to the managing node 210 includes information about a user account, the password for the user account, the IP address of the terminal 300, the IP address of the managing node 210, and the content type information. Such information is required when the terminal 300 requests contents according to the standard file transfer protocol (FTP). The IP address of the terminal 300 is required for the local server 230 or the wide area server 100 to transmit the contents, and the content type information defines whether the entire content is requested or the partial content is requested.

The content transmission message transmitted from the managing node 210 to the local server 230 and the wide area server 100 includes information about a content location, a user process registration identification, a server process registration identification, the size of content to transmit, and a content transmit rate. The user process registration identification and the server process registration identification are identification information that enables the managing node 210 to identify each local server 230 or the wide area server 100, and the content transmit rate is a transmit rate decided by the managing node 210 by considering the level of processing load in the local server 230 or a bandwidth. According to the content transmit rate, the content is transmitted between the local servers 230, between the local server 230 to the wide area server 100, or to the terminal 300. If the available bandwidth increases while transmitting the content, the content transmit rate may also increase.

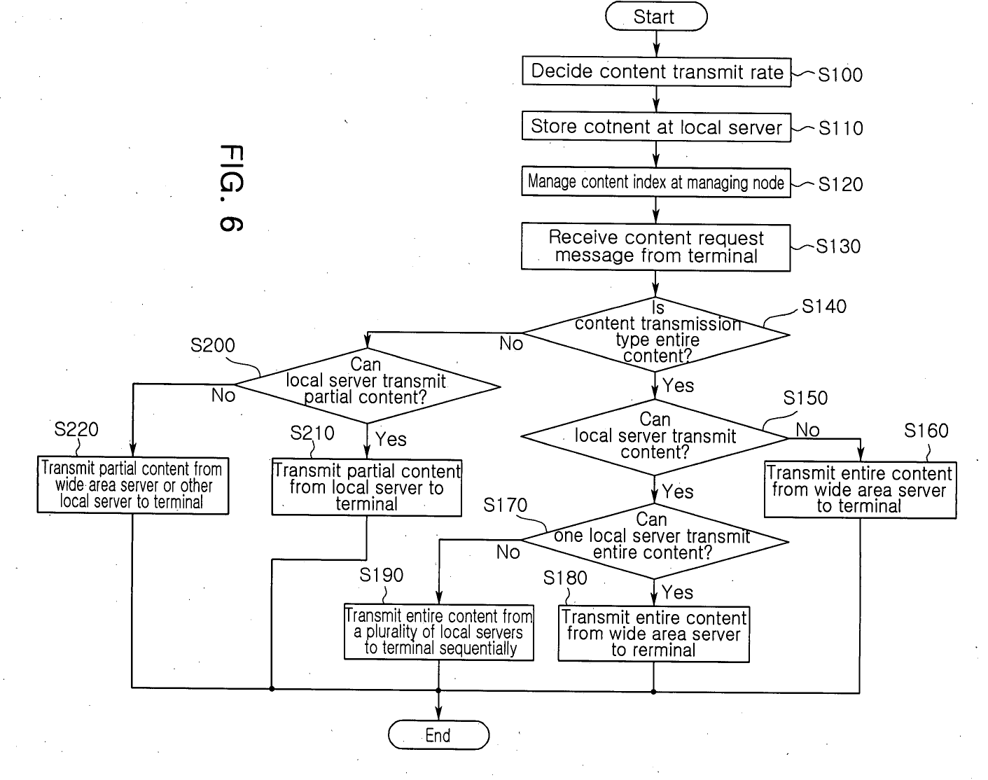

FIG. 6 is a flowchart illustrating a method of providing contents according to an embodiment of the present invention.

Referring to FIG. 6, the managing node 210 of each content providing system 200 decides a content transmit rate by measuring a bandwidth or a processing capacity to transmit contents at step S100. Each of the local servers 230 receives contents from the wide area server 100 according to the content transmit rate and stores them at step S110. Each of the local servers 230 and the wide area server 100 transmit the state information of available content, which is the context index information, to the managing node 210, and the managing node 210 manages the context index information of available contents, which can be provided from the local servers 230 or the wide area server 100, as like as the management scheme shown in FIG. 4 at step S120. That is, the managing node 210 may manage the storing locations P of the contents C which can be provided from each of the local servers 230 or the wide area server 100, and also manages the start and end information S and E of a content stored in each storing location P.

If the managing node 210 receives a content request message from the terminal 300 at step S130, the managing node 210 checks the content type information requested from the terminal 300 at step S140. That is, the managing node 210 determines whether the content requested from the terminal 300 is the entire content or the partial content. Herein, the content request message may includes a user account, the password of the user account, the IP address of the terminal 300, the IP address of the managing node 210 and the content type information.

The managing node 210 determines whether the local server 230 can transmit a corresponding content or not at step S150 when the content type is the entire content. Herein, the managing node 210 uses the context index information of the content to determine whether the local server 230 can provide the corresponding content. If the local server 230 cannot provide the entire content because the entire content is not stored in the content storing unit 240 connected to the local server 230, the managing node 210 transmits a content transmission message to the wide area server 100. Herein, the content transmission message may include a content location, a user process registration identification, a server process registration identification, the size of the content to transmit and a content transmit rate.

When the wide area server 100 receives the content transmission message, the wide area server 100 transmits the corresponding content to the terminal 300 at step S160.

If there is a local server 230 that can provide the corresponding content, the managing node 210 determines whether the local server 230 can provide the entire content or not at step S170. If the local server 230 stores the entire contents, the managing node 210 transmit a content transmission message to the local server 230, and the local server 230 transmit the entire content to the terminal 300 at step S180.

If the local server 230 does not have the entire content, the managing node 210 searches storing locations where the entire content sequentially is stored. Then, the managing node 210 sequentially transmits content transmission messages to local servers 230 having the searched storing locations so as to transmit the entire content to the terminal 300 at step S190. Furthermore, if the content type of the content request message is the partial content, the managing node 210 checks the location of the request partial content, such as the start information and the end information.

Then, the managing node 120 determines whether there is a local server 230 that can provide the requested partial content from the start information to the end information or not based on context index information at step S200. If there is a local server having the requested partial content, the managing node 210 transmits a content transmission message to the corresponding local server 230. Then, the corresponding local serve 230 transmits the requested partial content from the start information to the end information to the terminal 300 at step S210. The content transmission message may include the start information and the end information of the content to transmit. If there is no local server for providing the requested partial content, the managing node 210 transmits a content transmission message to the wide area server 100 or transmits a content transmission message to local servers 230 in the other content providing system 200 at step S220.

Meanwhile, when a terminal 300 requests a partial content, the managing node 210 searches local servers 230 or a wide area server 100 which have corresponding content from the context index information of contents and transmits a content transmission message with content size information such as start information and end information to the local server 230 or the wide area server 100. Then, the local server 230 or the wide area server 100 transmit the corresponding partial content to the terminal 300 according to the start information and the end information included in the content transmission message. Therefore, the predetermined portion of the content can be transmitted to the user although the user requests a predetermined portion of the content according to the present invention.

As described above, the content providing system according to the present invention manages the context index information of the contents stored in each of the servers although the requested content is distributed in a plurality of local servers or the wide area server in the streaming system that provides contents without interruption through a wired/wireless Internet network. Therefore, a delay time for a streaming service can be minimized, and a streaming service can be effectively and reliably provided to a user.

Also, the content providing system according to the present invention can provide a predetermined portion of the entire content to a user if the user requests the predetermined portion of the entire content only.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A content providing system connected to at least one of wired/wireless terminals and a wide area server, for supporting a streaming service, the content providing system comprising:
at least one of local servers for storing contents received from the wide area server and providing context index information of the contents; and
a managing node for managing the context index information by the contents stored in each of the local servers and the wide area server, determining a location of storing a corresponding content from the context index information according to type information of the corresponding content if a content request message is received from a terminal, and transmitting a content-transmission message to local servers having the corresponding content or the wide area server so that the local servers or the wide area server transmit the content requested by the terminal to the terminal through a wired/wireless Internet network.

2. The content providing system of claim 1, wherein the context index information includes at least one of information about identification of each of the contents, storing location of each of the contents, and starting information or end information of the stored content.

3. The content providing system of claim 1, wherein the wide area server transmits the context index information of each of the contents to the content providing system and transmits an entire content or a partial content to a corresponding terminal according to a content transmission message received from the content providing system.

4. The content providing system of claim 1, wherein the managing node searches local servers that store the entire content if the content type information included in the content request message is entire content information, and transmits the content transmission message to the wide area server if no local server having the entire content is searched.

5. The content providing system of claim 1, wherein the managing node searches local servers having a partial content if the content type information included in the content request message is partial content information, and transmits the content transmit message to the wide area server if no local server having the partial content is searched.

6. The content providing system of claim 1, wherein if a content requested through the content request message is distributed into at least one of local servers, the managing node sequentially transmits a content transmission message to corresponding local servers or the wide area server according to start information and end information of the content stored in each local server in order to sequentially transmit the distributed contents stored in the local servers or the wide area server.

7. The content providing system of claim 1, wherein the content transmission message includes at leas one of information about storing locations of the content, a user process registration identification, a server process registration identification, a size of content to transmit, start information, end information and a content transmit rate.

8. The content providing system of claim 7, wherein the managing node decides the content transmit rate by measuring a bandwidth and a processing capacity of the each local server or the wide area server for transmitting contents.

9. The content providing system of claim 1, wherein the content request message includes at least one of information about a user account, a user account password, an address of a terminal, an address of a managing node and a content type.

10. The content providing system of claim 1, wherein the local server or the wide area server includes a content transmission managing unit for managing the stored context index information, and transmitting the content to a corresponding terminal according to content size information, start information and end information in the received content transmission message.

11. The content providing system of claim 10, wherein the content transmission managing unit includes:
an index managing unit for managing the stored context index information;
a process analyzing unit for analyzing a content transmission type when a content transmission message is received, and determining whether the content is stored or not using the index information;
a content processing unit for reading a corresponding content according to storing location information, start information or end information of the content, which are checked at the process analyzing unit, and storing contents received from other local servers or the wide area server;
a content transceiving unit for transmitting the contents read from the content processing unit or receiving contents from the wide area server or other local servers; and
a content state processing unit for transmitting content index information and content state information, which are managed in the index processing unit, to a managing node.

12. A streaming service system comprising:
at least one of terminals for receiving a content through a wired/wireless Internet network and providing a streaming service to a user;
a wide area server for storing contents for a streaming service and transmitting the contents; and
at least one of content providing systems including at least one of local servers for storing contents received from the wide area server, managing content index information of contents stored in each of the local servers and the wide area server, and transmitting contents from a corresponding local server or the wide area server to a corresponding terminal by checking content index information according to a content request message received from each of the terminals.

13. The streaming server system of claim 12, the content providing system includes:
at least one of local servers for storing contents received from the wide area server and providing index information of the contents; and
a managing node for managing the index information by the contents stored in each of the local servers and the wide area server, determining a location of storing a corresponding content from the index information according to type information of the corresponding content if a content request message is received from a terminal, and transmitting the requested content to the terminal through a wired/wireless Internet network by transmitting a content-transmission message to local servers having the corresponding content or the wide area server.

14. A method of providing contents for supporting a streaming service in a content providing system connected to at least one of wired/wireless terminal and a wide area server, the method comprising the steps of:
a) at each of the local servers, storing contents received from the wide area server;
b) at a managing node, managing content index information by the contents stored in each of the local servers;
c) detecting local servers having a corresponding content by analyzing the content index information if a content request message is received from a terminal through a wired/wireless Internet network, and transmitting a content transmission message to the detected local server; and
d) at the detected local server, transmitting the content to the corresponding terminal.

15. The method of claim 14, wherein the content index information includes at least one of information about identifications of each of the contents, storing locations of each of the contents, and start and end information of the stored contents.

16. The method of claim 14, wherein the step b) includes the steps of:
b-1) at the wide area server, transmitting content index information to the managing node; and
b-2) at the managing node, managing the content index information stored in each of the local servers and the wide area server.

17. The method of claim 14, wherein the content request message includes at least one of information about a user account, a user account password, an address of a terminal, an address of a managing node and a content type.

18. The method of claim 14, wherein in the step c), local servers that store an entire content are searched if the content type information included in the content request message is entire content information, and a content transmission message is transmitted to the wide area server if no local server having the entire content is searched.

19. The method of claim 14, wherein in the step c), local servers having a partial content are searched if the content type information included in the content request message is partial content information, and a content transmit message is transmitted to the wide area server if no local server having the partial content is searched.

20. The method of claim 14, wherein in the step c), if a content requested through the content request message is distributed into at least one of local servers, a content transmission message is sequentially to corresponding local servers or the wide area server according to start information and end information of the content stored in each local server in order to sequentially transmit the distributed contents stored in the local servers or the wide area server.

21. The method of claim 14, wherein in the step c), a partial content requested from a user is selected according to content size information, start information and end information in the received content transmission message, and the selected partial content is transmitted.

22. The method of claim 14, wherein the content transmission message includes at leas one of information about storing locations of the content, a user process registration identification, a server process registration identification, a size of content to transmit, start information, end information and a content transmit rate.

23. The method of claim 14, wherein the managing node decides the content transmit rate by measuring a bandwidth and a processing capacity of the each local server or the wide area server for transmitting contents.

24. The method of claim 14, wherein in the step d), the local server or the wide area server select a corresponding content according to content storing location information and content size information included in a content transmission message, and the selected content is transmitted to a corresponding terminal according to the content transmit rate.

25. The method of claim 14, further comprising the steps of:
receiving a content from the wide area server or other local servers, and storing the received content;
managing content index information stored in each of the local servers and the wide area server;
analyzing a content transmission type if a content transmission message is received, and determining whether a corresponding content is stored or not from the content index information;
reading a corresponding content according to the content index information and transmitting the read content to a corresponding terminal; and
transmitting content index information and content state information to a managing node.
